(19) United States
(12) Patent Application Publication
(10) Pub. No.: US 2006/0048174 A1
(43) Pub. Date: Mar. 2, 2006

(54) Thin disk drive

(76) Inventor: Masahiko Nishide, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/199,191

(22) Filed: Aug. 9, 2005

(30) Foreign Application Priority Data
Aug. 30, 2004 (JP) 2004-250331

(51) Int. Cl. G11B 7/08

(52) U.S. Cl. 720/658

(57) ABSTRACT

In order to reduce thickness of a disk drive including a traverse unit having a turntable for rotating a disk placed thereon and an optical pickup for recording and playing back the disk, and a rack-loading member disposed in a position opposite to front end of the traverse unit slidably in a left-and-right direction perpendicular to an orbit in which the disk is transported and having a cam groove formed therein in which a boss formed at the front end of the traverse unit is loosely fitted so that the traverse unit moves up or down according to the movement of the rack-loading member in the left-and-right direction, a tilted surface is formed by cutting the lower surface of a front end portion of the boss, thus thinning the boss.

### BACKGROUND OF THE INVENTION

1. Field of the Invention

The present invention relates to a disk drive having a tiltable traverse unit to which a turntable is mounted.

2. Related Art

In a disk drive, a disk is loaded on a turntable and rotated thereon, and an optical pickup moves with the rotation to play back and record signals. One main method of transporting and loading a disk onto the turntable uses a tray. Another main method is to directly insert a disk from an opening formed in the front side of the disk drive.

Even where any of these means for transporting and mounting a disk onto a turntable is adopted, if the turntable is in a position where the disk can be played back when the disk is transported into the disk drive, the disk will collide against the turntable. Accordingly, the turntable, a motor for rotationally driving the turntable, and an optical pickup device for reading signal information from the disk are mounted in a traverse unit, and the traverse unit is mounted so as to be tiltable about its rear end between a disk playback position and a transportable position where the disk playback mode is deactivated. When the disk is transported in the disk drive and reached a given position, the traverse unit moves up to hold the disk between the turntable and a clamper In this way, the disk is loaded.

All conventional traverse units of general structure are common in terms of fundamental structure regarding tilting mechanism. The rear end of a traverse unit is pivotally mounted to the body of the disk drive. A cam groove 4 formed in a rack-loading member 2 (see FIG. 7) permits the front end of the traverse unit to move up and down, the rack-loading member being mounted slidably in the left-and-right direction (perpendicular to the orbit in which the disk is transported). As shown in FIG. 7, the cam groove 4 formed in the rack-loading member 2 consists of an upper groove portion 4a, a lower groove portion 4b, and a tilted groove portion 4c which are continuous with each other. The width b of the lower groove portion 4b is set greater than the width a of the upper groove portion 4a such that the relationship b>a holds.

As shown in FIGS. 8A and 8B, the rear end of the traverse unit 1 is pivoted by a shaft 1a. A cylindrical boss 3 protrudes from the front end and the boss 3 is loosely fitted in the cam groove 4 formed in the rack-loading member 2. FIG. 8A shows the state in which upward movement of the front end side of the traverse unit 1 has completed and the unit is in a position where playback of the disk is possible. FIG. 8B shows the state in which downward movement of the front end side of the traverse unit 1 has completed and the unit is in a position where the tray can be transported into a disk exchange position. The front end side of the traverse unit 1 is moved up and down according to movement of the rack-loading member 2 in the left-and-right direction. That is, the front end side of the traverse unit 1 is moved up and down according to movement of the boss 3 up and down, the boss being loosely fitted in the cam groove 4.

To permit the traverse unit 1 to swing in the up-and-down direction, the disk drive needs to have a given height wise dimension permitting the swinging motion. When the traverse unit 1 is in its elevated position shown in FIG. 8A, the boss 3 is loosely fitted in the upper groove portion 4a without gap. However, in its lowered position shown in FIG. 8B, a gap 5 is produced with the lower groove portion 4b. When the traverse unit 1 moves up and the disk is loaded on the turntable to make recording or playback, the traverse unit 1 must be in position stably. Any gap between the upper groove portion 4a and the boss 3 should not be present. However, when the traverse unit 1 moves down, it swings and tilts about the shaft 1a as shown in FIG. 8B. As a result, to permit the boss 3 to be loosely fitted in the lower groove portion 4b, it is necessary to increase the groove width b slightly. As the width b of the lower groove portion 4b is increased in this way, the height wise dimension of the rack-loading member 2 is increased accordingly. This increases the thickness wise dimension of the disk drive.

For example, JP-A-2003-223776 discloses a disk drive consisting of a miniaturized movable body for tilting a drive chassis (traverse unit). One longitudinal end of the drive chassis on which the disk press member is mounted is installed on a machine frame through a first buffer body. A free end of the drive chassis is connected, through a second buffer body consisting of a rubber vibration insulator, to the movable body which is guided so as to move up and down by a cam groove of a cam plate disposed at the point opposite to the free end of the drive chassis. The movable body is made of a hollow cylindrical axial body, and the second buffer body intervenes in a pressured state between the axial body and a protrusion projecting from the free end of the drive chassis.

With this structure, however, the width wise dimension of the disk drive can be reduced but the thickness wise dimension of the disk drive cannot be reduced. That is, the boss in the form of a hollow cylindrical axial body is mounted through the buffer body to the boss at the front end of the traverse unit. Therefore, the width of the cam groove is increased and the height wise dimension of the cam plate (rack-loading member) is rather increased. As a result, the thickness wise dimension of the disk drive is increased.

### SUMMARY OF THE INVENTION

The present invention is intended to solve the foregoing problem in the prior art disk drive. It is an object of the present invention to provide a disk drive whose thickness has been reduced by using a rack-loading member having a reduced height wise dimension.

A disk drive according to the present invention includes a traverse unit having a turntable for rotating a disk placed thereon, an optical pickup for recording and playing back the disk, and a rack-loading member placed in a position opposite to the front end of the traverse unit so as to be slidable in a left-and-right direction perpendicular to an orbit in which the disk is transported. The rear end of the traverse unit is connected with the body of the disk drive via a resilient member. The rack-loading member is provided with a cam groove composed of an upper groove portion, a lower groove portion, and a tilted groove portion in communication with the upper and lower groove portions. The traverse unit has a boss protruding from its front end. The boss is loosely fitted in the cam groove formed in the rack-loading member such that the traverse unit can tilt up and down as the rack-loading member is moved in the left-and-right direction. The boss has a front end portion cut out to form a tilted surface in contact with the lower groove portion of the cam groove.

The tilted surface is formed in the front end portion of the boss in this way. Therefore, when the traverse unit is in its elevated position, the base portion of the boss is loosely fitted in and in contact with the upper groove portion of the cam groove. When the traverse unit is in its lowered position, the tilted surface on the front side cut out to permit tilt is in contact with the lower surface of the lower groove portion. Therefore, the width of the lower groove portion of the cam groove can be reduced. The height of the rack-loading member can be reduced accordingly. Consequently, the thickness of the disk drive can be reduced. That is, if the distance that the traverse unit travels in making upward or downward motion remains the same, the disk drive can be thinned. The thickness wise dimension of the disk drive can be reduced without deteriorating the rigidity of the boss by cutting out the front end side of the lower surface of the boss without reducing whole dimension of the boss.

Preferably, the tilted surface of the front end portion of the boss is so formed that it is substantially parallel to the lower surface of the lower groove portion of the cam groove when the traverse unit is in its lowered position, because this form can reduce the thickness wise dimension to the greatest extent.

According to the present invention, the tilted surface is formed by cutting out the lower surface of the boss at the front end of the traverse unit, thereby allowing to reduce the width of the lower groove portion of the cam groove, the height wise dimension of the rack-loading member, and hence the thickness of the disk drive.

Furthermore, since the lower surface of the front end portion of the boss has been cut out, the boss loosely fitted in the lower groove portion makes a linear or planar contact, thereby stabilizing the traverse unit in its lowered position. Therefore, when the traverse unit is in its lowered position, rattling can be prevented and unpleasant sound due to external shock or vibration can be suppressed. This can lead to improvement of the quality of the disk drive.

### BRIEF DESCRIPTION OF THE DRAWING

FIG. 1 is a plan view showing a disk drive according to the present invention in a state in which a tray has been conveyed out of the drive;

FIG. 2A is a side elevation partially in cross section of the disk drive in which the tray has been conveyed out and a traverse unit has descended;

FIG. 2B is a side elevation partially in cross section of the disk drive in which the tray has been conveyed in and the traverse unit has ascended;

FIG. 3 is a plan view of a disk drive having no tray;

FIG. 4 is a front elevation of a rack-loading member of the disk drive;

FIGS. 5A and 5B are side elevations partially in cross section of the disk drive showing the relation between the boss of the traverse unit and the rack-loading member;

FIGS. 6A-6E are front elevations showing motion of the boss when the rack-loading member is moved;

FIG. 7 is a front elevation showing the prior art rack-loading member; and

FIG. 8 is a cross section partially in cross section of the prior art disk drive, showing the relation between the boss of the traverse unit and the rack-loading member.

### DETAILED DESCRIPTION OF PREFERRED EMBODIMENT

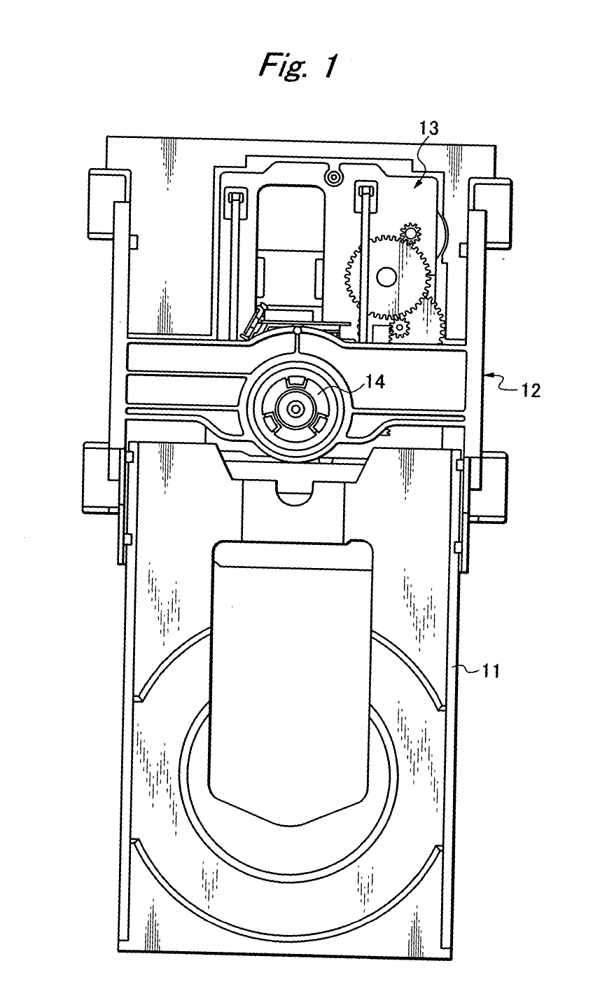

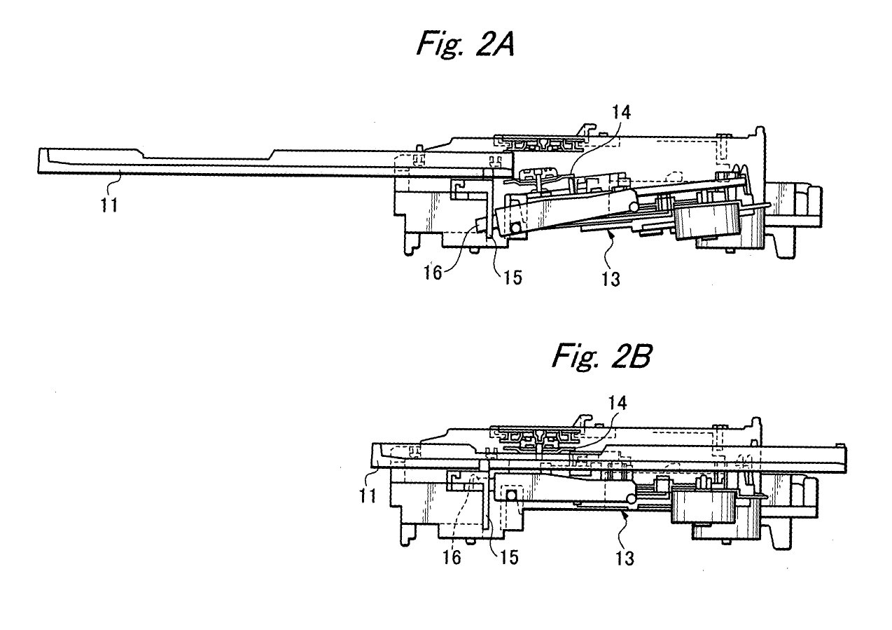

FIG. 1 shows a disk drive equipped with a tray according to one embodiment of the present invention. The body of the disk drive is generally indicated by reference numeral 12 and has the tray 11. The body 12 includes a traverse unit 13 having a turntable 14 to be placed a disk to rotate, a motor for driving the turntable, and an optical pickup that moves to read information from the disk. When the tray 11 is conveyed out of the body 12 of the disk drive and in a disk exchange position, the traverse unit 13 is in its lowered position as shown in FIG. 2A. When the tray 11 has been transported in and is in a disk playback position, the traverse unit 13 has ascended and in a horizontal state as shown in FIG. 2B. When the traverse unit 13 has descended, the turntable 14 is in a position lower than the passage through which the disk is conveyed in. When the tray 11 is conveyed in and the disk has reached a given position, the traverse unit 13 ascends and the turntable 14 is fitted in the central hole formed in the disk. The traverse unit 13 is formed as a support structure that prevents transmission of vibration or shock to the traverse unit 13 such that the distance between the disk and the optical pickup is kept constant even if such vibration or shock acts on the body of the disk drive.

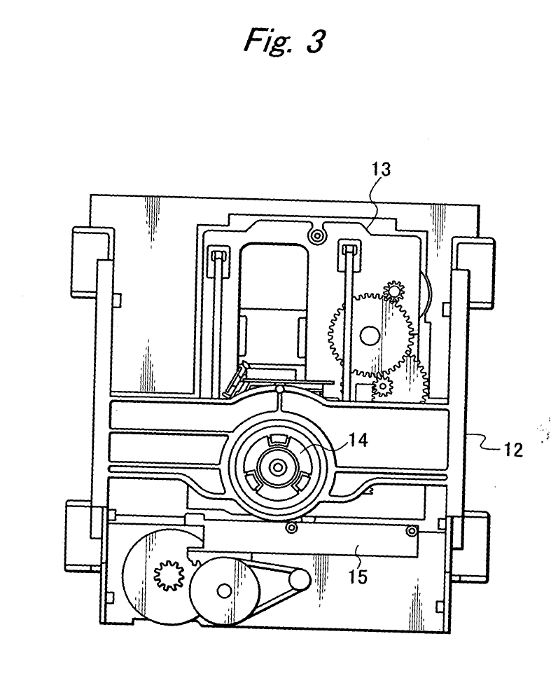

FIG. 3 shows a disk drive according to another embodiment of the invention. This disk drive is equipped with no tray. A disk is directly inserted into the disk drive from the entrance in the front side of the body 12 of the disk drive. When the disk is inserted, the traverse unit 13 ascends and the disk is placed on the turntable. In this way, any type of disk drive according to the present invention has the traverse unit 13. As the disk is conveyed in or out, the traverse unit 13 moves up or down. The traverse unit 13 is moved up or down by sliding motion of a rack-loading member 15 in the left-and-right direction.

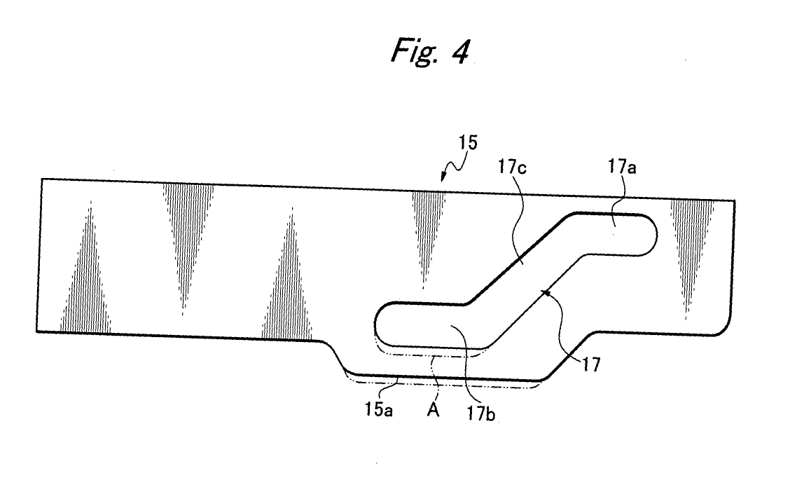

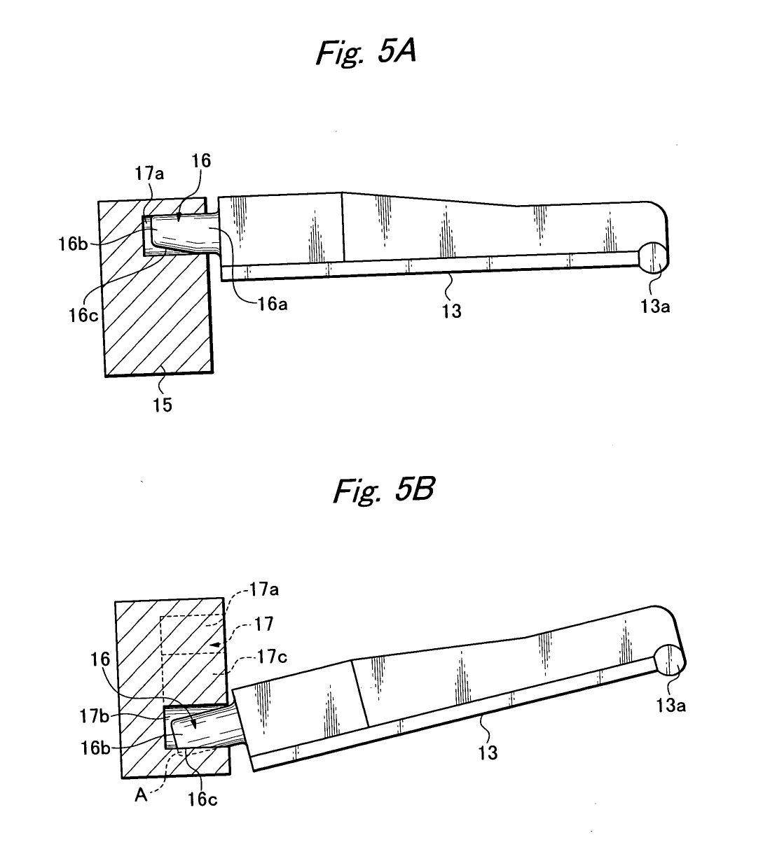

As shown in FIG. 4, the rack-loading member 15 is provided with a staircase-like cam groove 17. An upper groove portion 17a, a lower groove portion 17b, and a tilted groove portion 17c are continuously formed like a staircase in the cam groove 17. The relation between the traverse unit 13 and the rack-loading member 15 is shown in FIGS. 5A and 5B. A substantially cylindrical boss 16 protrudes from the front end of the traverse unit 13 and is loosely fitted in the cam groove 17 of the rack-loading member 15. FIG. 5A shows the case where the boss 16 is in the upper groove portion 17a, i.e., the traverse unit 13 is in its elevated position. FIG. 5B shows the case where the boss 16 is in the lower groove portion 17b, i.e., the traverse unit 13 is in its lowered position. As the rack-loading member 15 moves in the left-and-right direction, the boss 16 is moved up or down between the upper groove portion 17a and the lower groove portion 17b through the tilted groove portion 17c, thus moving the traverse unit 13 up or down. The present disk drive is identical with the prior art disk drive in this respect.

The boss 16 of the traverse unit 13 loosely fitted in the cam groove 17 is not perfectly cylindrical but the lower side of a front end portion 16b has been cut out to form a tilted surface 16c, whereby the boss is thinned, while the base portion 16a remains cylindrical. When the traverse unit 13 is in its elevated position shown in FIG. 5A, the base portion 16a of the boss 16 is loosely fitted in the upper groove portion 17a of the cam groove 17. On the other hand, in its lowered position shown in FIG. 5B, the cutout front end portion 16b of the boss 16 is loosely fitted within the lower groove portion 17b.

As shown in FIG. 5B, the cutout tilted surface 16c of the front end portion 16b of the boss 16 is placed horizontally and makes a linear or planar contact with the lower surface of the lower groove portion 17b of the cam groove 17 when the traverse unit 13 is in its lowered position and tilted. Where the front end portion 16b of the boss 16 is not cut out, the width of the lower groove portion 17b must be increased up to the position of a point A at the front end as indicated by the phantom line. Since the lower surface of the front end portion of the boss 16 has been cut out, the width of the lower groove portion 17b is reduced. This makes it possible to reduce the height wise dimension of the rack-loading member 15. That is, as indicated by the phantom line in FIG. 4, the lower groove portion 17b can be placed at a higher position than conventional one by cutting out the lower surface of the front end portion. Consequently, the lower side 15a of the rack-loading member 15 is also placed at a higher position. Thus, the height wise dimension can be decreased.

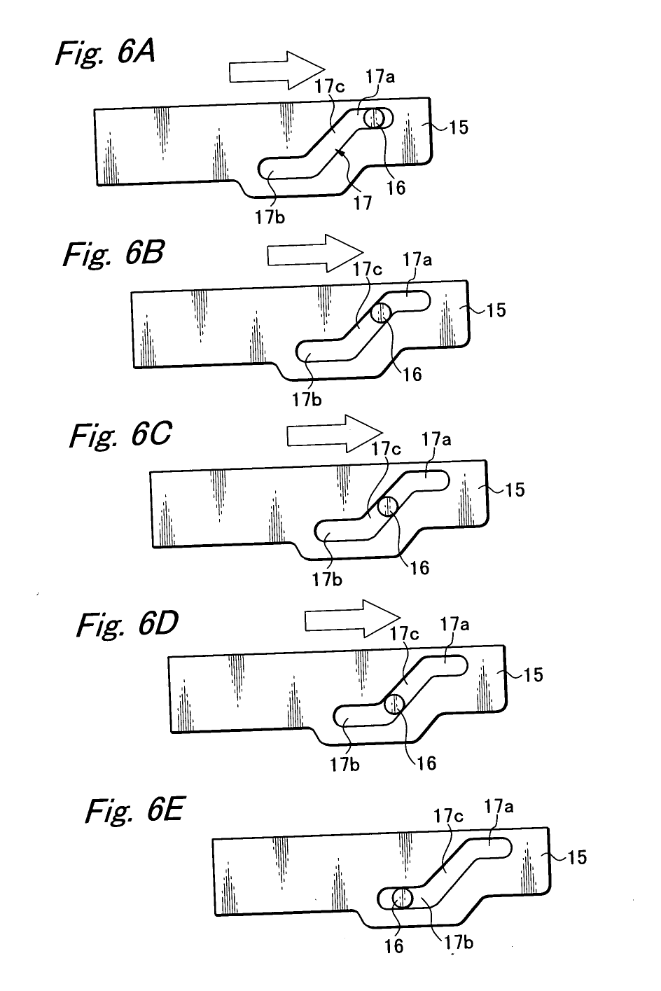

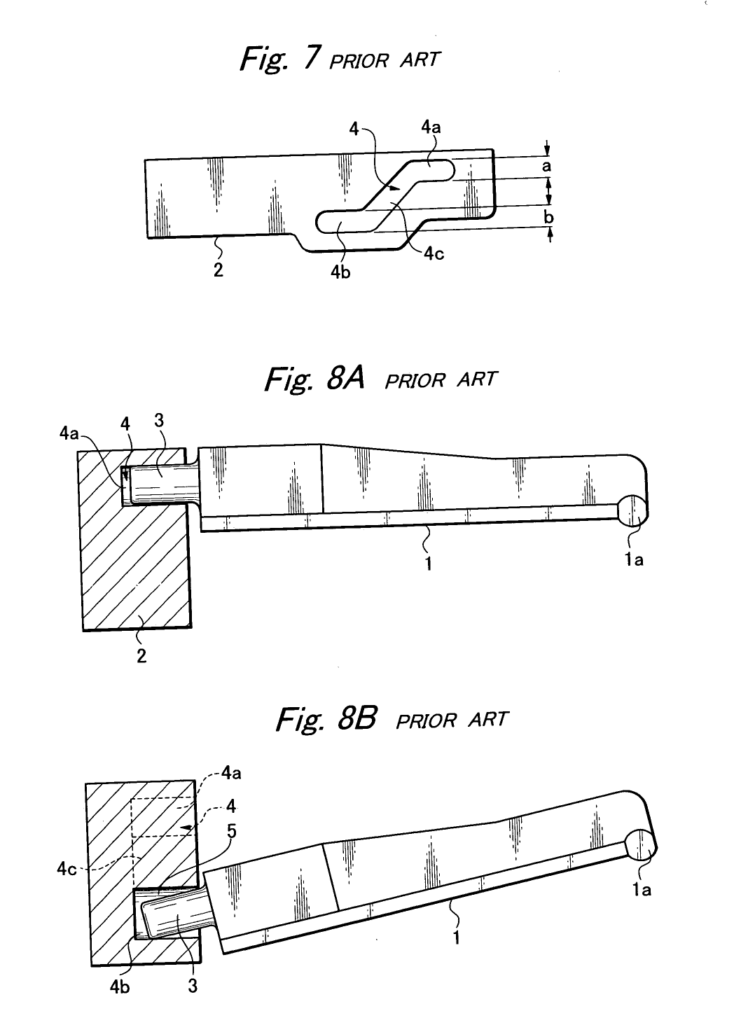

FIGS. 6A-6E show motion of the rack-loading member 15 and motion of the boss 16 when the traverse unit 13 moves from its elevated position to its lowered position. When the rack-loading member 15 moves to the right as indicated by the arrows, the boss 16 concomitantly moves from the upper groove portion 17a into the lower groove portion 17b through the tilted groove portion 17c. FIG. 6A shows the case where the boss 16 is located within the upper groove portion 17a. FIGS. 6B, 6C, and 6D show the case where the boss 16 is located within the tilted groove portion 17c. FIG. 6E shows the case where the boss 16 is located within the lower groove portion 17b.

What is claimed is:

1. A thin disk drive comprising a traverse unit having a turntable for rotating a disk placed thereon and an optical pickup for recording and playing back the disk, and a rack-loading member disposed in a position opposite to front end of the traverse unit slidably in a left-and-right direction perpendicular to an orbit in which the disk is transported, the traverse unit being connected at rear end to a body of the disk drive via a resilient member, wherein
the rack-loading member is provided with a cam groove composed of an upper groove portion, a lower groove portion, and a tilted groove portion in communication with the upper and lower groove portions;
the traverse unit has a boss protruding from the front end of the traverse unit;
the boss is loosely fitted in the cam groove of the rack-loading member such that the traverse unit is made tiltable up and down according to movement of the rack-loading member in the left-and-right direction; and
the boss has a tilted surface formed by cutting out a front end portion that is in contact with the lower groove portion of the cam groove.

2. A thin disk drive according to claim 1, wherein the tilted surface of the front end portion of said boss is so formed as to be substantially parallel to the lower surface of the lower groove portion of the cam groove when the traverse unit is in its lowered position.
